(19) United States
(12) Patent Application Publication
(10) Pub. No.: US 2019/0286449 A1
(43) Pub. Date: Sep. 19, 2019

(54) SYSTEM AND METHOD FOR AUTOMATED AGGREGATION OF SYSTEM INFORMATION FROM DISPARATE INFORMATION SOURCES

(71) Applicant: Cloudamize, Inc., Philadelphia, PA (US)

(72) Inventors: Stephan Karl Bohacek, Philadelphia, PA (US); Khushboo Shah Bohacek, Philadelphia, PA (US)

(73) Assignee: Cloudamize, Inc., Philadelphia, PA (US)

(21) Appl. No.: 16/464,054

(22) PCT Filed: Nov. 28, 2017
(86) PCT No.: PCT/US17/63454

§ 371 Date: May 24, 2019

Related U.S. Application Data
(60) Provisional application No. 62/426,953, filed on Nov. 28, 2016.

(51) Int. Cl. G06F 9/30; G06F 8/71

(52) U.S. Cl. CPC G06F 9/30156; G06F 8/71; G06F 9/30152

(57) ABSTRACT

A program analysis system for evaluating a target program on a target computer system, said program analysis system comprising: a processor; a memory operatively coupled to said processor; a program analyzer component comprising instructions stored in said memory and operable to cause said system, to analyze said target computer system to identify first information characteristics of said target program; an information determiner component comprising instructions stored in said memory and operable to cause said system, to review one or more of information sources external from said target computer system to identify second information characteristics associated with said target program; and an information fuser component comprising instructions stored in said memory and operable to cause said system, to fuse said first information characteristics and said second information characteristics to generate fused information and store information associating said first and second information characteristics within said memory.

### CROSS-REFERENCE TO RELATED APPLICATION

This application claims the benefit of priority of U.S. Provisional Patent Application No. 62/426,953, filed Nov. 28, 2016, the entire disclosure of which is hereby incorporated herein by reference.

### FIELD OF INVENTION

The present invention relates generally to computer analytics and more particularly to a system and method for analyzing computer system to compile relevant information from a plurality of disparate sources.

### BACKGROUND

Current computer systems are very complicated and include a variety of programs all having different requirements and that may span over multiple different computer devices. By way of example, the complexity is particularly acute in the context of an enterprise system in which it is very difficult to understand which programs are running within the system, as well as the details and requirements of those programs, to facilitate changes to the programs or the related infrastructure. To further complicate matters, the services provided by infrastructure providers are complex and rapidly changing.

Routinely, changes to one or more aspects of a computer system are implemented. These changes may include changes to software, hardware, bandwidth elements, and/or changes to other aspects of the system. In various instances, these changes may be made in concert, where changes to one aspect may require changes to another aspect. For example, upgrading software may necessitate changes to hardware and/or bandwidth elements of the computer system. In another example, changes to the cost efficiency of a computer system may require changes to the other aspects of the computer system. In some instances, software and/or hardware elements of the system may be changed to take advantage of commercially-available services. These services may provide data storage, management and processing through the use of at least one remote server. In order to support upgrading or changing one or more elements of a computer system, it is helpful to have a robust understanding of the programs, information and capabilities of the computer system as well as how any changes or upgrades will affect the computer system.

One example of a commercially-available service is a cloud computing infrastructure. Cloud computing infrastructures may help reduce long-term infrastructure cost and reduce the complexity of managing a large local computer system. However, moving programs to a cloud computing infrastructure is complicated as there are various providers with different services and it is difficult to understand the requirements of the programs that are to be moved. As such developing an effective, efficient and/or workable plan for migration is a complex task that is prone to errors and sub-optimization. Current solutions include a manual review of the programs that are to be moved, the features of the computer system and the features of the various cloud services and providers. This is a complex and inexact process. As such there would be a significant benefit received from a system capable of automated gathering of information from a plurality of disparate sources and displaying that information in support of manual development a cloud transition plan. However, there are no current systems that are able to gather information from a plurality of disparate sources and display that information. Further, additional benefits would be received from a system capable of not only an automated gathering and displaying of information from a plurality of disparate sources, but also generating a cloud transition plan based on correlated information acquired from disparate information sources. However, there are no current systems that are able to generate a transition plan based on correlated information acquired from disparate information sources, namely, the programs, the computer systems and the external information sources.

Program information may be acquired from a computer system through the use an application program interface (API). However, current systems that support system evaluation or program/data migration are limited in that they are only capable of obtaining program information from the local computer or from computers in the same network. These systems do not attempt to identify information that is external to the computer system or that is from different resources within the same computer system. For example, the current systems do not identify information that it is generated by users stored within other files stored within a computer system. These systems are only concerned with obtaining information from processes related to the program and installed application information and are not able to acquire data from disparate sources. Since current systems are deficient in gathering information from disparate data sources, system operation in support of migration planning and/or activities must often be supplemented by manual review, which is time-consuming, complex, error-prone, and subject to sub-optimization.

### DESCRIPTION OF THE FIGURES

An understanding of the following description will be facilitated by reference to the attached drawings, in which:

FIG. 1 is a block diagram of an exemplary program analysis system in accordance with the present invention, shown in the context of an exemplary communications network;

FIG. 2 is a block diagram illustrating an exemplary program analysis system in accordance with the present invention;

FIGS. 3A-3C are flow diagrams illustrating exemplary methods for identifying and combining information using the various components of the program analysis system;

FIGS. 4 is a block diagram illustrating exemplary processing of information from disparate information source systems;

FIG. 5 is a block diagram illustrating exemplary information sources used by the system for the identification of information from disparate information sources;

FIG. 6 is an exemplary output user interface element in accordance with the present invention; and

FIG. 7 is a flow diagram illustrating an exemplary method for evaluating a target program on a target computer system in accordance with the present invention.

### DETAILED DESCRIPTION

The following describes systems and methods for obtaining and combining program information from a target computer system as well as from external information sources to provide an improved understanding of programs and data on and the features of a computer system.

In various embodiments, the process of upgrading one or more programs may be improved with a better understanding of the programs to be upgraded. Upgrading a program may include changing some parts of the source code or another part of the program. For example, when upgrading a database, it is important to understand which programs use a database and how those programs interact with the database. In other embodiments, a change to a program may include making a change to the computational resources, enhancing performance, changing cost and increasing reliability.

In other embodiments, redesigning or managing programs may be improved with a better understanding of the programs. Redesigning one or more programs may include changing a substantial portion of one or more programs, and managing one or more programs may include detecting one or more problems within the program or related programs and correcting one or more of the issues identified.

In the examples above, the term “understanding” corresponds to gaining information related to one or more of the following: behaviors of the programs (e.g., functions the programs perform), interactions the program has with other programs, complexity of the program specifically related to the task objective, related components of the program such as DLL and shared libraries, programming frameworks (e.g., Microsoft's .NET), software platforms, operating system requirements such as the version of the operating system, computational requirements such as memory requirements, and communication requirements such as a requirement to have low latency or high bandwidth between one or more programs, or the lack of such requirements.

In one specific example, the objective comprises moving one or more programs to a cloud computing service, and the information about complexity includes information for determining difficulty in moving the programs to the cloud, which includes information about firewall settings, permissions (e.g., access control lists), network configurations (e.g., SDN configurations), estimated number of hours it would take or has taken to migrate the program, one or more problems faced when moving the program and work-arounds to those problems, the set of other entities that have skills and /or experience with the program, and information about whether and under what conditions the program should be moved as is, upgraded, or redesigned.

The following description describes a system and method for identifying and combining information from various disparate sources for one or more programs on a computer system. Previous systems use an API to communicate with an operating system, making operating system calls to analysis programs within a computer system. However, these systems are not able to identify information from other information sources within the computer system that are not accessible through an API, and thus are inadequate for addressing the technical problem rooted in computer technology that generally arises from the need to analyze programs and data, and/or to develop a migration plan, e.g., in support of migration of computing programs or other resources to a cloud-based computing infrastructure. Such information sources may include documents stored within the computer system, databases on the computer system and/or email clients. Further, these systems are not able to identify information on sources external to the computer system and combine the information from all the disparate systems into a concise format for review or into a proposed migration plan. The proposed system greatly reduces, and in some embodiments eliminates the need for manual review of programs and computer system that are to be upgraded or moved to a new infrastructure.

The programs comprise one or more active processes running on a device of the computer system. The programs may further comprise one or more software applications installed on a device of the computer system. The computer system may comprises one or more devices. For example, the computer system may comprise a single computer. In another example, the computer system may comprise one or more computers communicatively coupled to a server, e.g., via an Ethernet or other communications network. In yet another example, the computer system may comprise one or more mobile devices, one or more computers, and one or more servers.

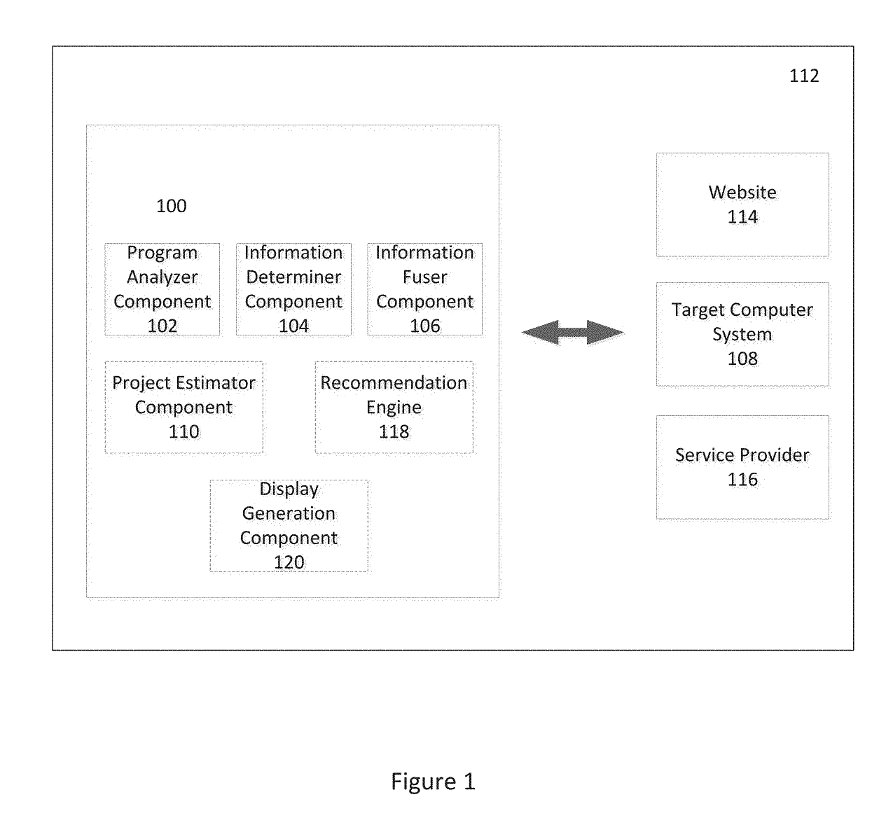

FIG. 1 is a system diagram showing an exemplary network computing environment 112 in which the present invention may be employed. FIG. 1 further shows program analysis system 100 within the network 112. Program analysis system 100 is configured to evaluate target programs on target computer system 108 that may be changed or upgraded, and/or have one or more of its resources migrated to a cloud-based computing environment. In accordance with the present invention, program analysis system 100 comprises a program analyzer component 102, an information determiner component 104 and an information fuser component 106, as are discussed in greater detail below. In optional embodiments, program analysis system 100 further comprises a project estimator component 110, a recommendation engine component 118, and/or a display generation component 120. System 100 is communicatively coupled via a communications network through one or more communication channels to remote information sources, such as target computer system 108, website 114 and service provider 116 within network 112.

As used herein, program analysis system 100 refers to one or more devices configured to interact with the target computer system 108. The program analysis system 100 may comprise any combination of hardware and software elements. In one embodiment, program analysis system 100 comprises conventional hardware and software typical of a general purpose computer, and further comprises special-purpose software in accordance with the present invention configuring the program analysis system 100 to communicate with a target system to obtain information related to one or more target programs within the target system, identify external information corresponding to the target program and combine that information to gain a better understanding of the target program. Program analysis system 100 is configured to analyze the target computer system to obtain first information for a target program, the first information characteristics corresponding to at least one of process information, application information and system information for a target program. Program analysis system 100 is further configured to review one or more data sources external to the target computer system to identify second information characteristics corresponding to the target program. Program analysis system 100 combines (or fuses) the first information characteristics and the second information characteristics. The combined (or fused) information may then be stored within a memory of the system and/or displayed by a display device. In one example, the fused information is displayed as a compilation within a graphical user interface (GUI) thereby providing the user with a greater understanding of the target program. The compilation includes information from disparate information sources, and as such provides a unitary compilation providing additional information previously unavailable via prior art systems. In one embodiment, program analysis system 100 is configured to generate an integrated display of fused information, e.g., within a single user interface window displayed in its entirety within a GUI window, without the need for scrolling, zooming of other adjustment of the view.

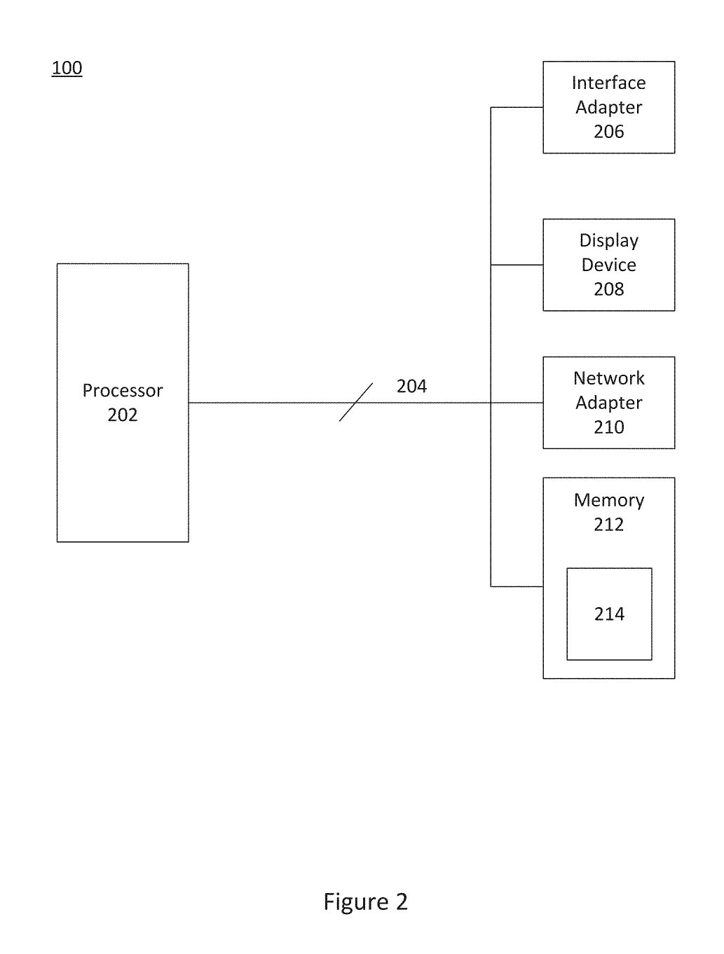

FIG. 2 is a block diagram of a program analysis system 100 in accordance with the present invention. Program analysis system 100 includes conventional computer hardware storing and/or executing specially-configured computer software that configures the hardware as a particular special-purpose machine having various specially-configured functional sub-components that collectively carry out methods in accordance with the present invention. Accordingly, program analysis system 100 of FIG. 2 includes a general purpose processor 202 and a bus 204 employed to connect and enable communication between the processor 202 and the components of the program analysis system 100 in accordance with known techniques. The program analysis system 100 typically includes a user interface adapter 206, which connects the processor 202 via the bus 204 to one or more interface devices, such as a keyboard, mouse, and/or other interface devices, which can be any user interface device, such as a touch sensitive screen, digitized entry pad, etc. The bus 204 also connects a display device 208, such as an LCD screen or monitor, to the processor 202 via a display adapter. The bus 204 also connects the processor 202 to memory 212, which can include a hard drive, diskette drive, tape drive, etc.

The program analysis system 100 may communicate with other computer systems, for example via a communication channel, network adapter 210. The program analysis system 100 may be associated with such other computer systems in a local area network (LAN) or a wide area network (WAN), and may operate as a server in a client/server arrangement with another computer, etc. Such configurations, as well as the appropriate communications hardware and software, are known in the art.

The program analysis system 100 software is specially-configured in accordance with the present invention. Accordingly, as shown in FIG. 2, the program analysis system 100 includes computer-readable, processor-executable instructions 214 stored in the memory 212 for carrying out the methods described herein. For example, memory 212 comprises processor-executable instructions corresponding to one or more of program analyzer component 102, information determiner component 104, and information fuser component 106. The processor-executable instructions stored on memory 212 may also correspond to a plan generator component, the project estimator component 110, the recommendation engine component 118 and the display generation component 120.

Memory 212 may be configured to store data received from one or more of the components. For example, memory 212 may store first information characteristics identified by program analyzer component 102 and second information characteristics identified by information determiner component 104. Memory 212 may be further configured to store fused information generated by information fuser component 106. Information fuser component 106 may be configured to communicate with one or more external information sources via the communication channel to identify information characteristics that corresponds to the target program and store that information characteristics within memory 212. As such, Memory 212 is configured to store information from disparate sources. The information characteristics provided by program analyzer component 102 and information determiner component 104 may be stored such that are referenced to the target program and/or target system. The fused information may be stored such that it is associated with corresponding first and second information characteristics. Memory 212 may also store plans generated by recommendation engine 118 for the target program. The plan may include information corresponding to the type of project, cost information of the project and timeframe information of the project generated by project estimator component 110. Processor 202 may access the fused information and/or plan stored within memory 212 to be displayed on the display of display device 208 within a graphical user interface.

A computer program product stored on a tangible computer-readable medium for carrying out the methods identified above is provided also. The computer program product comprises computer readable instructions for carrying out the methods described herein. In one embodiment, an exemplary computer program product comprises a tangible computer-readable medium storing a software application comprising a first instruction set for causing a computing device to provide primary application functionality, and a second instruction for causing the computing device to provide access to a defined operational mode only after receipt of configuration settings from a back-end server, the configuration settings configuring the software application to enter the defined operational mode in response to receipt of predefined user input via an input device of the computing device.

The present invention may be understood with further reference to the exemplary simplified network environment 112 of FIG. 1. As shown in FIG. 1, the exemplary network environment 112 includes conventional computerized information systems 108, 114, and 116. Each of these conventional information systems provides information as described below and each of these systems provides access to data in a conventional manner. These systems 108, 114, and 116 collectively provide disparate information feeds from disparate information sources. In one example, website 114 provides a data feed including data gathered and aggregated from a first website, and service provider 116 provides a data feed including social media content data gathered from the computer system of a service provider. In alternative embodiments, a single data reporting system may provide the disparate data feeds, and in other alternative embodiments, the data feeds may be provided in different forms.

Program analyzer component 102 may be a software element running within a device of program analysis system 100 and may be communicatively coupled to the target computer system 108. In one embodiment, program analyzer component 102 comprises instructions stored in memory 212 which are executable on processor 202. Program analyzer component 102 may communicate with an API running on the target computer system 108 via a communication channel and use the API to identify first information characteristics regarding the target program and store those in memory 212. In other embodiments, program analyzer component 102 may comprise any combination of hardware and software used to interact with the target computer system 108. In one embodiment, program analyzer component 102 communicates with target computer system 108 via a communication channel to analyze the target computer system to identify information characteristics for the target program. The program analyzer component 108 may analyze at least one of process data, application data and system data within the target computer system 108 to identify first information for a target program. The target program corresponds to a program that is being evaluated for possible upgrading, redesigning, managing and/or further understanding. In one embodiment, the target program corresponds to one program of a set of programs that are being evaluated in concert. Program analyzer component 102 may communicate with the target computer system 108 via a communication channel to obtain a list of process information, application information and system information for a target program. Further, program analyzer component 102 may store information received from target computer system 108 within memory 212. Program analyzer component 102 may also communicate information to information determiner component 104 and/or information fuser component 106.

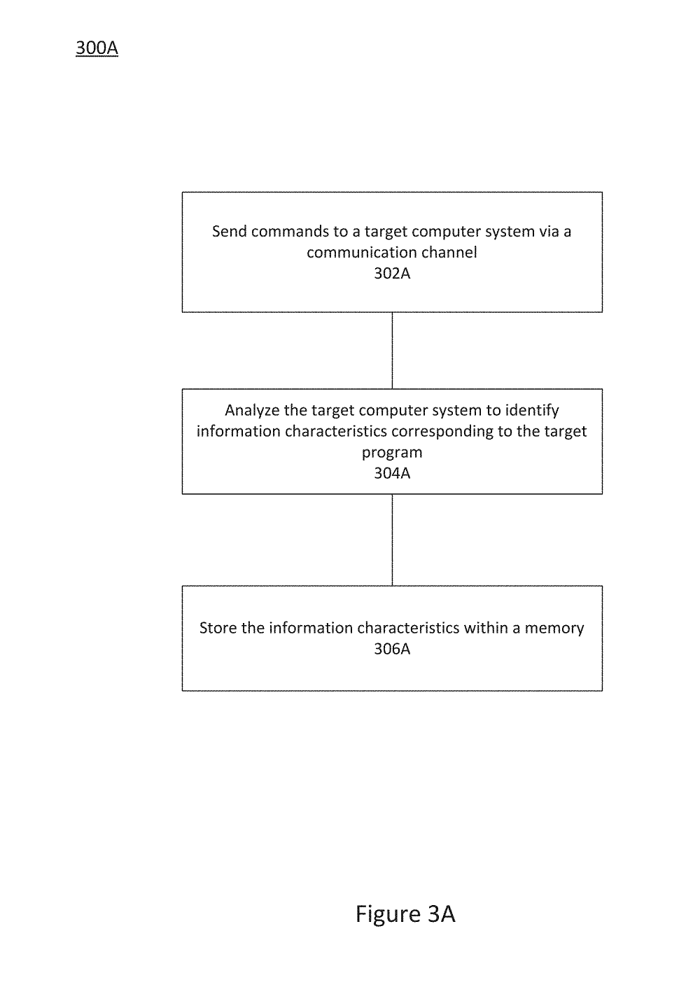

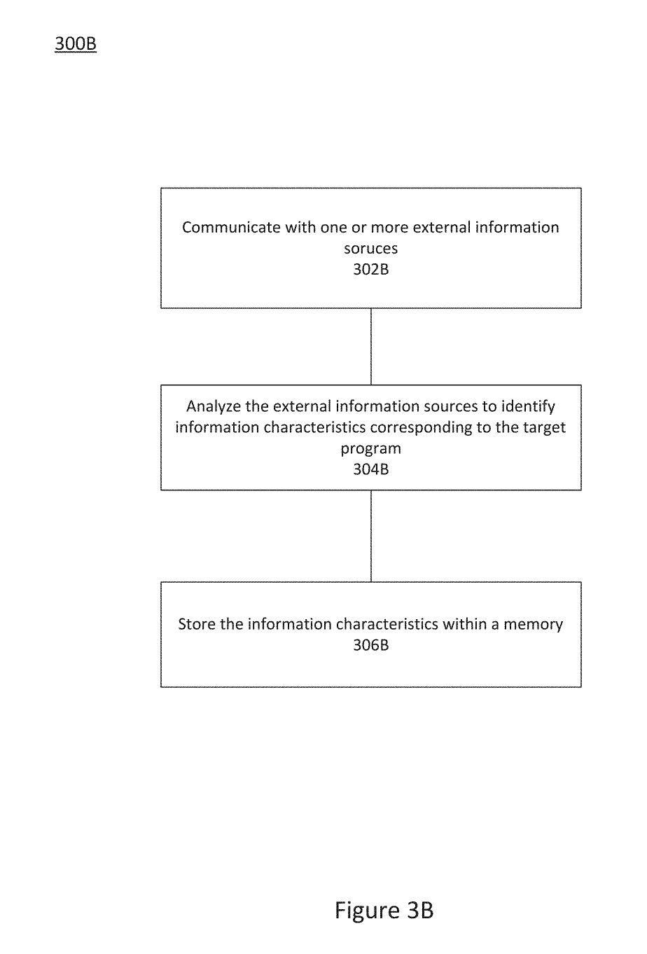

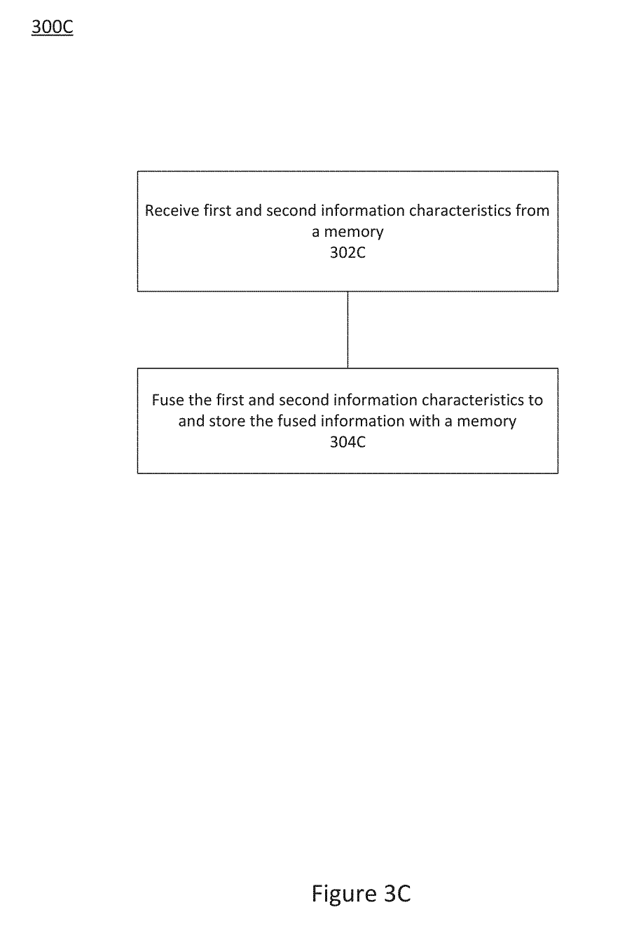

FIG. 3A is a flow chart illustrating an exemplary method carried out by program analyzer component 102 to identify information characteristics for a target program on a target computer system. As indicated by block 302A, program analyzer component 102 sends commands to the target computer system 108 via a communication channel. In one embodiment, instructions corresponding to program analyzer component 102 stored within memory 212 are executed by processor 202 to initiate the functionality of the program analyzer component 102. The commands may be provided through the use of an API within the operating system of the target computer system or they may be any function calls within the operating system that can be executed by a program running on or in communication with the target computer system. In block 304A, program analyzer component 102 analyzes the target computer system 108 to identify information characteristics for the target program. Program analyzer component 102 may perform one or more searches of the target computer system to analyze process information, application information and system information to identify information characteristics corresponding to the target program. The searches may be completed using function calls or by communicating through an API. Program analyzer component 102 then provides instructions to save the identified information characteristics within memory 212 as indicated by block 306.

The first information may comprise any one of process data, application information and system information and may correspond to data on a single device of the target computer system or to multiple devices of the target computer system. In some embodiments, first information corresponds to information obtained from devices interacting with a program and devices which impact the program. Further, the first information may be acquired from devices running similar programs to the target program and other programs interacting with the target program. In one embodiment, program analyzer component 102 uses operating system functions to obtain additional information corresponding to said target program. The operating system functions can be called from a software agent running on the devices where the target program is running or by making operating system calls from another software agent that is not on the target computer system but has the ability to execute operating system function calls remotely and has access to a data repository that includes the results of operating system function calls. In other embodiments, information is gathered by executing programs that gather information about a process running within the target computer system. Examples of these programs include packet capture programs and other programs able monitor processes running on an operating system. Process information may include the name of the target program, any information embedded into the program, the DDL and shared libraries used by the program, performance information for the program, command lines used to execute the program, configuration files used by the program, network connection information, network bandwidth information, communication information and operating system calls made by the target program.

In various embodiments, information embedded in programs can be collected by calling functions provided by the operating system. This information may include a program description, program name, company name, service name, service display name and/or the location of the program on the corresponding file system. Function calls provided by the operating system may be used to collect the DLL and shared libraries used by the target program. The performance information may comprise memory, processor, network and/or storage resources which may be collected by calling operating system functions that provide performance metrics. In various embodiments, program analyzer component 102 is configured to use operating system calling functions to collect information corresponding to command lines used to execute the target program. Configuration files used by the target program may be acquired by first obtaining the command line arguments used to execute the program, detecting the configuration file in the command line arguments and then reading those files. Detecting configuration files can be achieved by testing each string in the command line arguments, or searching for typical file name formats, such as a string that ends with a period followed by a small number of characters.

Network connection information may include the server address, server port, client address, client port, transport protocol, duration, start time, and/or number of bytes sent by the server and the number of bytes sent by the client between the components of the target program and between this program and other programs. In one or more embodiments, program analyzer component 102 collects network connection information through the use of a program that can collect this data or through direct methods that can be found within the operating system. In various embodiments, program analyzer component 102 may be configured to collect network bandwidth information. The network bandwidth information may include short-term bandwidth and longer-term bandwidth, where these bandwidths may computed by tracking the number of bytes sent over different time periods. The network bandwidth information may be obtained by recording times when data packets are sent, or by communicating with an operating system on the target computer via the communication channel to call functions provided by the operating system to determine the amount of data being sent and received.

Details corresponding to communication with other programs may include programs that communicate with the target program, network connection information used for the communication between the programs, bandwidth used by the communication with other programs, latency of the responses which may be measured by timing the delay from when a message is sent to when a reply for the message is received and operating system function calls made by the target program. In one embodiment, latency of responses can be measured by observing when a request is made by the client process and observing the duration until the response arrives from the server. This can be measured by observing a message being sent from the client to the server, and then observing the response from the server. Operating system calls may be collected by using operating system tracing tools.

In various embodiments, program analyzer component 102 prompts the operating systems via the communication channel to provide a list of installed applications and corresponding information within the computer system. This list may correspond to applications that are installed on one or more devices of the computer system. The information for the installed applications may include a name of the vendor of the application, the location in the filesystem where the application is installed and/or the version of the application. As with information related to the processes, a list of installed applications may be acquired by using operating system functions that can be called from a software agent running on the target computer system devices where the target program is running. Additionally, operating system calls from another software agent that is not on the target computer system may be implemented. Such operating system calls have the ability to execute operating system function calls remotely and access a data repository that includes the results of operating system function calls.

Information determiner component 104 may be any combination of hardware and software elements. In one particular embodiment, information determiner component 104 comprises instructions stored in memory 212 which are executable on processor 202. Information determiner component 104 is configured to identify program information corresponding to the target program from various sources within the target computer system or external to the target computer system. These sources are described in greater detail below. Information determiner component 104 may be communicatively coupled to a plurality of external sources and the target computer system via a communication channel and acquire information characteristics from each of those sources and store the information characteristics within memory 212. In one embodiment, information determiner component 104 receives information characteristics pertaining to said target program to identify additional information stored within the target computer system and/or sources external from said target computer system.

FIG. 3B is a flow chart illustrating an exemplary method carried out by information identifier component 104 to identify additional information characteristics corresponding to the target program. As indicated by block 302B, information identifier component 104 communicates within one or more information sources external from the target computer system via a communication channel to identify information characteristics for the target program. Information identifier component 104 may also be configured to communicate with the target computer system to identify additional information. In one embodiment, processor 202 executes instructions stored within memory 212 to initiate the communication by the information identifier component 104. Information identifier component 104 searches the information sources and identifies additional information characteristics for the target program. In one embodiment, information identifier component 104 generates and performs an query within an internet search engine to identify information characteristics. Further, the information identifier component 104 may communicate with the operating system of the of the target computer system and instruct the operating system to perform a system level search, access and search information public information provided by another entity and/or search information stored within a local memory such as memory 212. At block 306B, the information identifier component 104 to store the identified information within memory 212. In one embodiment, information identifier component 104 stores a list of identified hyperlinks within a table of memory 212. Information identifier component 104, may also store documents, video files, image files and text files within memory 212. In some embodiments, video files, and audio files may be search by performing speech to text conversion as well as searching meta data of the files that includes information about the topics covered in the multimedia files.

In one or more embodiments, information determiner component 104 may receive first information characteristics from program analyzer component 102, the target computer system 106, memory 212 or another element within program analysis system 100. Information determiner component 104 may then use this the information characteristics to examine one or more information sources to identify additional information characteristics corresponding to the target program. Information determiner component 104 stores the additional information characteristics within memory 212. The one or more information sources may include the target computer system and/or sources external to the target computer system. In various embodiments, the external information sources include internet sources and other computer systems (e.g., website 114 and service provider 116). The other computer system may or may not be communicatively coupled to the target computer system. The information determiner component 104 may be configured to review documents, video files, image files and audio files through instructions executed on processor 202. These documents may be web pages, text, PDF, program source code, configuration files, or other formats. Further, the documents may include user's manuals for the target program, email messages or online forums about the target program, and web pages that discuss the target program. In one embodiment, the information includes video files that discuss the target program such as marketing material and tutorials. In other embodiments, this information includes information regarding programs related to the target program, that is, the subject matter of the information need not be directly about the target program. For example, the information can be about other programs that achieve a similar objective as the target program.

Information determiner 104 analyzes the information characteristics identified by program analyzer component 102 that are stored within memory 212 to augment the review performed by information analyzer 104. In various embodiments, information determiner component 104 receives the program information from program analyzer component 102 or memory 212 and generates one or more search parameters based on the program information. The search parameters may include any combination of process, application and system information. In one embodiment, information determiner component 104 generates a plurality of search parameters based on the program information. The searches may be tailored according to one or more information sources and/or type of information. For example, when examining emails stored within the target computer system, the information determiner component 104 may create a query string comprising the process and application information for the target program such that all emails the mention either the process and application information or obtained. Additionally, when reviewing external sources, the information determiner component 104 may look for additional information that not only references the process and application information but also system information to obtain documents that discuss any possible complications that other entities may have observed.

In some embodiments, information determiner component 104 receives information pertaining to the corresponding project for the target program. For example, information determiner component 104 may receive, from the target computer system or another source, a data instruction that the corresponding project pertains to upgrading the target program. As such, the information determiner component 104 may then communicate via the communication channel with the various sources to process and store within memory 212 information not only regarding the target program, but also regarding features of the upgraded program and store that information within memory 212. This information may include system parameters that meet the requirements of the upgraded program as well as any documentation of any difficulties others have faced when performing such an upgrade. This information may be used to ensure that the upgraded program will operate as expected within the computer system. In another embodiment, information determiner component 104 receives notification that the project corresponds to a change in the infrastructure of the target computer system. For such a project, the information determiner component 104 may search for information that not only discuss the target program, but also that discuss the target program with regard to the updated infrastructure. As can be seen the information analyzer is configured to perform more than a simple machine query. The information analyzer is configured to examine multiple information sources which may be external to the target computer system to obtain information based on the target program and, in some embodiments, also based on the corresponding project, and process and store that information within a memory.

In various embodiments, information identifier component 104 correlates information from various sources to provide access to information gathered by processing documents, video files, image files, and audio files. Information identifier component 104 acquires more than just basic information for a target program. Information identifier component 104 not only analyzes the target computer system, but also all other available information source to obtain information corresponding to the target program. In some instances, information identifier component 104 obtains information not only corresponding to the target program but also to a corresponding project. In one embodiment, information identifier 104 is configured to process the information such that is easier to comprehend, make conclusions and/or provide proposals regarding the overall project objective. Some examples of this type of information include summaries of text related to the program that have been derived from documents that include discussions about program being studied, short text strings of text or short segments of video and audio are extracted from documents and files that are relevant to user's objective, relevant terms extract from documents and links to documents, videos files, image files and audio files generated by a web search related to the program being studied. In one exemplary embodiment, the summaries are generated using well-known summary-generation techniques.

In one example, information identifier component 104 receives and processes a data control signal to determine that the object of the project corresponding to the target program is to migrate the target program to a different infrastructure. Such a project not only requires consideration of the target program parameters, but also the latency parameters of the target infrastructure. In this an example, information identifier component 104 communicates with the information sources via a network to identify documents and files that are searched for discussion on latency, and process and store within memory 212 the relevant segment of identified text, video files, and/or audio files. Information identifier component 104 may store summaries of one or more of the identified files within memory 212.

In one or more embodiments, the system includes a number of keywords. These keywords, if present, are extracted from the documents. Additionally, information identifier component 104 may communicate with the operating system of the information systems via a communication channel to instruct the operating system to use standard named entity recognition function calls to detect new terms. One or more links to documents, video files, image files and audio files may be generated by a web search related to the program being studied. These links are generated by performing web searches for one or more of vendor words, product words, process name, service name, service display names, etc.

In various embodiments, the information identifier component 104 communicates with the information sources via a communication network to identify, process and store user-generated information within memory 212. The user-generated information may be located within one or more of the devices of the target computer system or within an external information source. In one embodiment, user-generated information comprises information entered by users into the target computer system regarding the target program. This information may include information about the user, the time when the information was entered, and the source or some justification of the quality of the information entered by the user. In one example, the type of information that users may enter includes information gathered through other means (e.g., information collected directly from a device of target computer system and information collected by processing documents found on at an external source, such as a remotely-located server accessible via the Internet). In other embodiments, the information may include specific challenges faced with regard to the target program and corresponding project, methods to address these challenges and configuration settings for the target program, such as firewall settings, permissions (e.g., access control lists) and network configurations (e.g., SDN configurations). In various embodiments, the information may be related to the corresponding project. Such information would include estimated and/or actual number of hours it would take someone to complete a specific task of the project, pricing estimates of how much it cost to complete a specific task of the project, and the set of people or companies that have skills and/or experience regarding the target program and corresponding project. In various embodiments, the information comprises whether and under what conditions the target program should be moved as is, upgraded, or redesigned, as well as best practices related to the target program. In one or more embodiments, information regarding the best practices includes operating system requirements such as the required version of the operating system, computational requirements such as memory requirements, communication requirements such as a requirement to have low latency or high bandwidth between this program and other programs or users, or the lack of such requirements, storage requirements in terms of performance and reliability, security requirements such as firewall settings, whether the program should be in the DMZ, auditing requirements, and details about data confidentiality requirements.

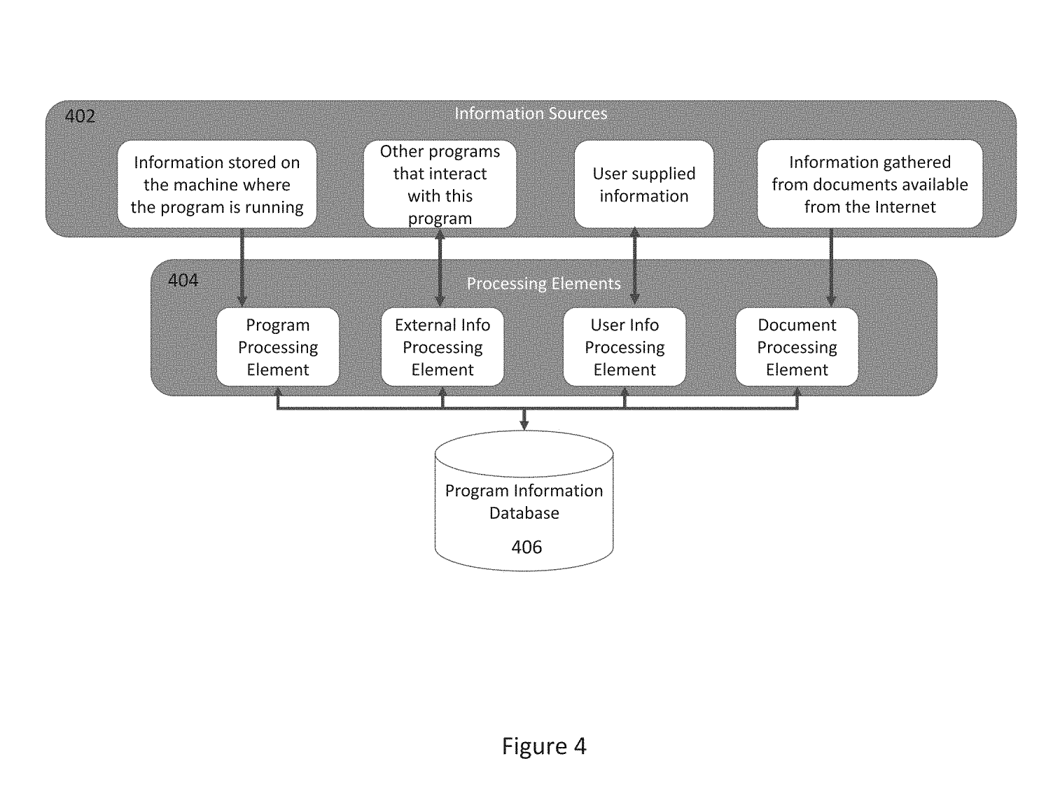

FIG. 4 illustrates an exemplary embodiment of information determiner component 104. The embodiment illustrated in FIG. 4 comprises information sources 406 and corresponding processing elements 404. Each processing element may be part of a common general purpose processor or may divided up among multiple general purpose processors. Each of the processing elements of processing elements 304 analyze the information provided by the information sources and store the analyzed information within the program information database. Program information database may be part of memory 212. In various embodiments, there may be greater or fewer information sources and processing elements. Further, in some embodiments, more than one information source may be analyzed by a single processing element.

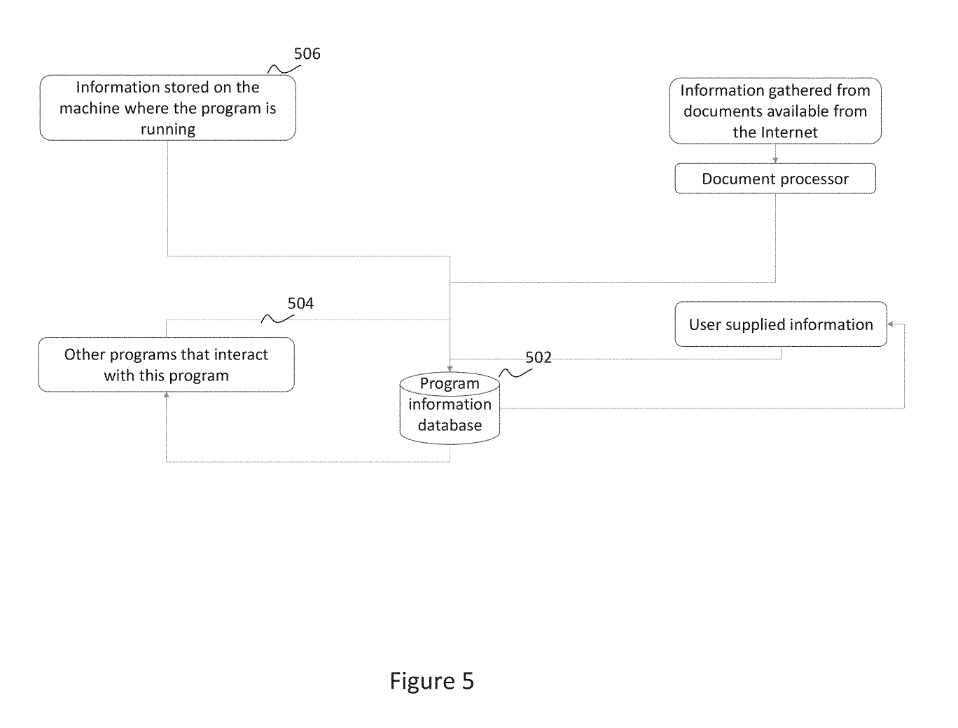

FIG. 5 illustrates the accumulation of information from various information sources into a common database, program information database 402. The information within program information database may be accessed and processed by information determiner component 104. In various embodiments, information determiner component 104 uses information within database 502 to acquire additional information from one more of the connected sources. For example, information determiner 106 may process information stored within database 502 received from source 506 to assist in the identification of information within source 504. In such an example, information determiner component 104 reviews database 302 to acquire a list of programs that interact with the target program based on information received from source 506, processes that information and generates search criteria to identify information within source 504. In various embodiments, as more and more programs are analyzed within more computer systems, the information available in the program information database 502 increases and, correspondingly, the information available when reviewing programs also increases. As is illustrated in FIG. 5, information determiner component 104 performs more than a simple search of one or more sources of information. Information determiner component 104 uses information from one or more sources to expand on and augment the information obtained from other information sources.

Information fuser component 106 combines or fuses information characteristics obtained by program analyzer component 102 and information determiner 104. The fused information combines the information characteristics for a target program such that information characteristics from disparate sources is associated with each other and accessible from other components within program analysis system 100. Information fuser component 106 may be any combination of hardware and software elements. In one particular embodiment, information fuser 106 comprises a plurality of instructions executable on processor 202.

In various embodiments, as the information about a specific program comes from different sources, there are several challenges in fusing together this information. For example, when dealing with information from disparate sources there is a challenge to detect whether different pieces of information are related to a same program. If the information is related to the same target program, then that information should be presented as a single piece of information. Several methods are described below to detect whether information is from the same target program.

FIG. 3C is a flow chart illustrating an exemplary method carried out by information fuser component 106 to generate fused data from the information characteristics identified by the program analyzer component 102 and information determiner component 104. As indicated by block 302C, information fuser component 106 receives information characteristics identified by program analyzer component 102 and information determiner component 104. In one embodiment, processor 202 executes instructions stored within memory 212 corresponding to information fuser component 106 to access and fuse the information characteristics. Information fuser component 106 receives information characteristics comprising process information, application information and system information from memory 212 obtained by program analyzer component 102 and receives information characteristics from memory 212 obtained by information determiner component 104. At step 304C of flowchart 300C, information fuser component 106 fuses first and second information characteristics to generate fused information and stores the fused information within memory 212. Fusing the information characteristics may comprise correlating data from the target computer system and from one or more external information sources such that the information is associated with each other within memory 212. The fused information characteristics may comprise characteristics from various disparate sources and an additional flag or bit set that associates the information with each other and the target program within memory 212. In one embodiment, the fused information characteristics corresponds to a lookup table stored within memory 212 that associates information from the various sources with each other.

In various embodiments, information characteristics from various sources are fused such that it is associated within memory 212 and accessible by components of the program analysis system 100. For example, information obtained from the target computer system may be fused with information for one or more external sources described above. In another example, information from different external sources may be fused together and associated within memory 212. Fusing may be performed by accessing and processing information within memory 212 to identify documents, video files, image files, and audio files that contain the vendor words, vendor abbreviation, and product words derived from the process information and list of installed applications and creating an association between those documents and files with memory 212. In various embodiments, not all documents and files identified are necessarily fused. For example, documents are ranked and those documents that are determined to provide insufficient information beyond the what is already provided by other documents or files are excluded.

The fused information characteristics for a target program stored within memory 212 may include information collected from the target computer system and other computer systems where similar programs are running. In various embodiments, the fused information characteristics further comprises information characteristics submitted by a user of the target program on the target computer system, information characteristics submitted by users on other computer systems. This information characteristics may include document

In various embodiments, process information and application information of a program are fused by matching the name of the program and the vendor. The process information may be matched with information collected from other sources. The process information may comprise the filesystem path of where the target program is located, and the company name, the product, filesystem paths given within command line arguments of the target program, filesystem paths given within configuration files that are listed in the command line arguments and the above information for the parent process of this process. Information fuser component 106 may process information stored within memory 212 and identified by other components of the system to derive one or more of vendor words, vendor keywords, vendor abbreviations, and product words. In one embodiment, the vendor words comprise the company name and vendor words derived from filesystem paths. Filesystem paths may be in the form “*/vendor words/*” or “\vendor words\*”, where * represents some arbitrary text. In one embodiment, the vendor words are surrounded by slashes. In some embodiments, the filesystem path takes the form “*/vendor words*” or “*/vendor words*”, that is, where the vendor words are only proceeded by a slash. Vendor keywords may be words that are contained in the vendor name that do not appear frequently in the other vendor names. For example, keywords do not include words like “Inc.” and “Systems”. In other embodiments, vendor abbreviations are derived from vendor words by removing all but the first letter of each word or removing all but the first letter of each word and letters within the words that are capitalized. For example, vendor words “Software CompanyOne” has abbreviations SC and SCO. Similarly, IBM is abbreviated as IBM. In yet other embodiments, product words may comprise product name, and product words derived from filesystem paths. The Filesystem paths sometimes are in the form or “*/product words/*” or “\product words\*”, that is the product words are surrounded by slashes. In some cases, the filesystem path takes the form “*/product words*” or “*/product words*”, that is, where the product words are proceeded by a slash. In many embodiments, information fuser 106 matches a process (and the associated process information) with an installed application if a match of vendor keywords, vendor abbreviations, or product words is made.

Information fuser component 106 accesses memory 212 to processes the stored information characteristics from various devices and/or computer systems to identify and fuse information characteristics that are similar via processor 202. The fused information characteristics are then stored within memory 212. Information fuser component 106 stores the fused information characteristics within memory 212. The information characteristics may be from devices within the target computer system and/or from other computer systems, such as computer systems from other entities. Information fuser component 106 may process the information characteristics to identify similar information characteristics based on vendor keywords, vendor abbreviations, product words can be matched, allowing information collected from different devices and computer system to be fused. Specifically, information about a target program from a first device, computer system and/or customer can be fused with the information about the target program from a second device, system and/or another customer. In one example, information fuser component 106 receives information corresponding to the target program and information about other programs from memory 212 and processes the information to generate the fused information. As such, information from different users or entities regarding corresponding programs may be automatically fused.

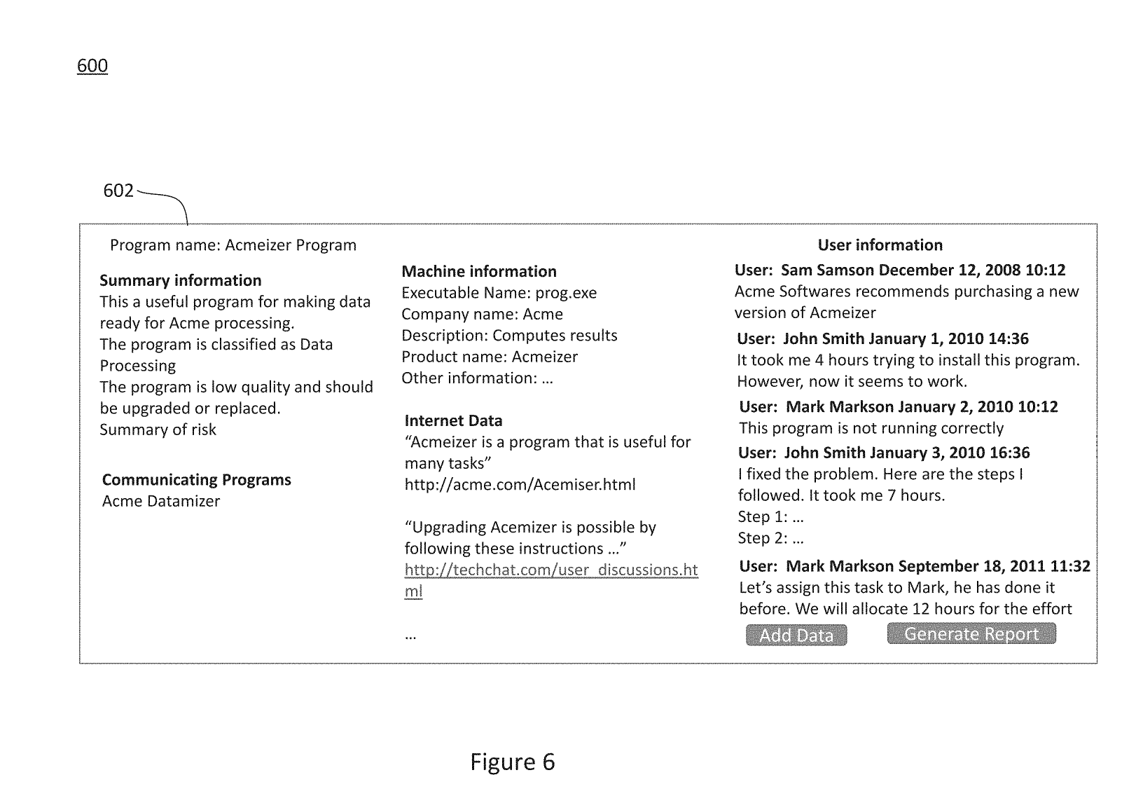

FIG. 6 shows an exemplary graphics user interface (GUI) window 602 of user interface 600 for one or more embodiments of the present invention. A display generation component 120 of program analysis system 100 processes the fused information characteristics within memory 212 to generate a GUI window 602 to be displayed on a display of a display device (e.g., display device 208). In one embodiment display generation component 120 performs a lookup in the lookup table corresponding to the target program to identify the fused information characteristics. In one embodiment display generation component 120 searches the information within memory 212 for a bit for flag indicating that the information is part of the fused information characteristics for the corresponding target program GUI window 602 comprises information fused from disparate information sources using the methods described above within a single element. GUI window 602 provides the information in a format that allows a user to browse compiled information. In one embodiment, display generation component 120 generates GUI window 602 such that a single user interface window is displayed in its entirety within GUI window 602 without the need for scrolling, zooming of other adjustment of the view, where the single user interface window displays all relevant information gathered from disparate (internal and external) information sources. GUI window 602 displays information for a target program such that a user is able to understand which program is being analyzed, the processes for the program within the computer system and what external information is available for that program. The information within GUI window 602 may be manually manipulated such that the user input may be provided to GUI window 602 through an input device coupled to interface adapter 206. The input may comprise user provided information characteristics, reorganization of the display fused data, removal of one or more information characteristics and the like. Display generation component 120 receives the input via interface adapter 206 and bus 204, updates the information within GUI window 602 and provides the updated GUI window via bus 204 to display device 208 to be displayed. In various embodiments, the type of information and/or how the information is displayed within GUI window 602 may differ based on the corresponding project for the target program. For example, cost information, time frame estimates and possible compilations may be displayed within GUI window 602 when the corresponding project is a change in an infrastructure for the target program.

In one exemplary embodiment, the display element may allow a user to navigate through a wide range of information in order to gain some specific knowledge and then record this knowledge. For example, the user can browse through the documents and videos related to network bandwidth required for the program being studied. A user may provide additional information, such as conclusions, comments and indications as to relative importance of the information, and display generation component 110 may update and refresh GUI window 602 based on the additional information.

In one embodiment, information characteristics provided by optional project estimator component 110 and/or optional recommendation engine 118 is fused with information characteristics within memory 212 by information fuser component 106 to generate updated fused information characteristics. Information fuser component 106 stores the updated fused information within memory 212, and display generation component 120 may process the updated fused information characteristics from memory 212 to generate an updated GUI window to be displayed on display device 208. In various embodiments, information fuser component 106 is able to fuse the information characteristics not only based on the available information but also based on the corresponding project for the target program. Information fuser component 106 may also process the fused data to detect possible problems and/or complexities for the target program, identify and rank entities having experience related to the target program and/or the corresponding project, and computation of costs and duration for the corresponding project. Further, information fuser component 106 may search the fused information to detect problems and complexities facing the target program, such as unexpected problems others have been faced when working with the target program. The indications may comprise at least one of whether others have added discussions of such problems in the user-added data, whether documents from external sources discuss problems faced when working with the program being studied, whether there is a lack of available guidance (such as documentation) about the program, and whether cost estimates of working with this program were small and whether these costs were significantly lower than the final cost. As is stated above, information fuser component 106 updates the fused information characteristics based on the additionally information characteristics and stores the updated fused information characteristics within memory device 212. Display generation component 120 may process the updated fused information characteristics from memory 212 and generate an updated GUI window to be displayed on display device 208.

Information fuser component 106 may identify and rank users having experience with the target program and the corresponding project from information stored within memory 212. Information fuser component 106 processes information within memory 212 to identify those that have worked with the target program as well as the user-added information added by others and corresponding company information. Further, information fuser component 106 detects which entities (i.e., other users and/or companies) have experience with the program at least partially based on the available information. The information may be ranked based on experience, cost estimates and user-added documentation about the program being studied.

Optional project estimator component 110 determines the cost and/or project duration estimates for a project that corresponds to the target program based on the information characteristics stored within memory 212. In various embodiments, project estimator component 110 is configured to determine estimates for at least one of the cost and/or project duration based on fused information characteristics stored within memory 212 . Project estimator component 110 uses costs estimates, actual costs, project duration estimates, and actual project duration obtained from different entities to estimate the project cost and duration. Project estimator component 110 provides the cost and/or proposed timeline data based on one or more of the cost and project duration estimate entered by the user, computing the average cost estimate and average project duration from all available information from other entities and computing the average cost estimate and average project duration based on that information. For example, cost information from other entities that have completed a similar project may be scaled based on the costs estimates and actuals reported by this entity.

Optional recommendation engine 118 automatedly develops and provides a migration or transition plan based on the fused information. For example, recommendation engine 118 receives and processes information from memory 212 to generate the migration or transition plan. The information may comprise information characteristics stored in memory 212 by either program analyzer component 102 and/or information determiner component 104. The information may alternatively or additionally comprise fused information characteristics stored by information fuser component 106. Recommendation engine 118 processes information characteristics for a target program stored within memory 212 to suggest a service provider and/or infrastructure. Recommendation engine 118 stores this suggestion within memory 212 and/or provides the suggestion to display generation component 120 to be displayed within GUI window 602. In one embodiment, project estimator component 110 process the suggestion provided by recommendation engine 118 to determine the estimated cost and/or project duration information. The estimated cost and/or project duration information may be stored to memory 212 where it may be accessed by display generation component 120 to be displayed as part of GUI window 602.

In one exemplary embodiment, recommendation engine 118 suggests a cloud computing provider and service based on information characteristics corresponding to the target program stored within memory 212. Recommendation engine 118 provides the suggested cloud computing provider and service to display generation component 120 (either directly or through memory 212) to be displayed within a GUI window 602 to a user. The displayed information may comprises one or more of the expected cost, project duration time frame and any possible issues that may be encountered. In such an embodiment, recommendation engine 118 processes the information characteristics corresponding to the target program to determine the requirements of each program that will be moved to a cloud platform and selects a corresponding platform based on those requirements. Recommendation engine 118 may access service provider information directly from a service provider system (service provider 116) via a communication channel or from information process and stored within memory 212. Recommendation engine 118 then analyzes information from one or more information sources via a communication channel or from memory 212 to determine if there are potential issues that may arise. Further, recommendation engine 118 may provide information that is determined to be possibly helpful during the migration to the new service such as documents or videos about the migration and/or information from other users regarding such a migration.

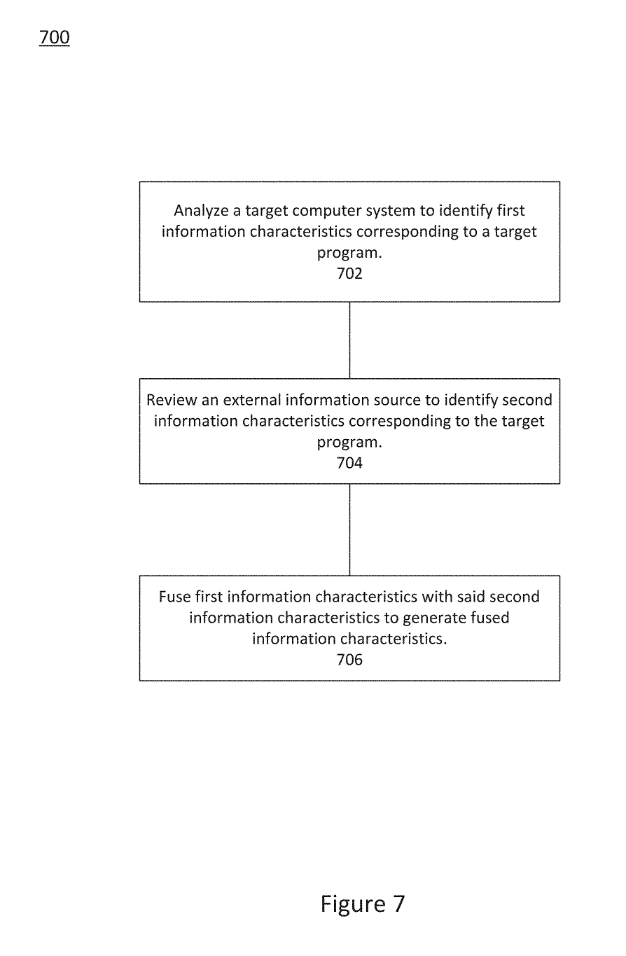

FIG. 7 illustrates flow chart 700 describing a exemplary method for evaluating a target program on a target computer system in accordance with of the invention. In block 702 the target computer system 108 is analyzed by program analyzer component 102 to identify first information characteristics corresponding to a target program according to instructions stored within memory 212 and executed on processor 202. This information may correspond to process, application and/or system information and is described in greater detail above. Program analyzer component 102 analyzes target computer system 108 via a communication channel. In one embodiment, program analyzer component 102 communications with target computer system 108 via a communication channel to execute one or more programs or function calls to analyze target computer system 108. Program analyzer component 102 stores the first information characteristics in memory 212. In block 704 one or more external information sources is reviewed by an information determiner component 104 to identify second information characteristics corresponding to the target program according to instructions stored within memory 212 and executed on processor 202. Information determiner component 106 communicates with each external information source via a communication channel and stores the identified second information characteristics within memory 212. In block 706, the first and second information characteristics are fused together by information fuser component 108, generating fused information, according to instructions stored within memory 212 and executed on processor 202. The information fuser component 108 receives and processes the first and second information characteristics from a memory 212 to generate fused information characteristics and stores the fused information characteristics within memory 212. The fused information may be in the form of a lookup table stored within memory 212 or as a bit of flag set along with the associated information characteristics. The fused characteristics may be provided to display generation component 120 to be displayed as part of a GUI window on display device 208. Various methods may be used to fuse different information characteristics and these methods as well as the information characteristic are described above. In various embodiments additional method steps may be included or one more of the illustrated method steps may be removed. Further, the illustrated method steps may performed in any order.

While certain embodiments according to the invention have been described, the invention is not limited to just the described embodiments. Various changes and/or modifications can be made to any of the described embodiments without departing from the spirit or scope of the invention. Also, various combination of elements, sets, features, and/or aspects of the described embodiments are possible contemplated even if such combinations are not expressly identified herein.

What is claimed:

1. A program analysis system for evaluating a target program on a target computer system, said program analysis system comprising:
a processor;
a memory operatively coupled to said processor;
a program analyzer component comprising instructions stored in said memory and operable to cause said system, under control of said processor, to analyze said target computer system to identify first information characteristics of said target program;
an information determiner component comprising instructions stored in said memory and operable to cause said system, under control of said processor, to review one or more of information sources external from said target computer system to identify second information characteristics associated with said target program; and
an information fuser component comprising instructions stored in said memory and operable to cause said system, under control of said processor, to fuse said first information characteristics and said second information characteristics to generate fused information and store said fused information associating said first and second information characteristics within said memory.

2. The program analysis system of claim 1 further comprising a display component comprising instructions stored in said memory and operable to cause said system, under control of said processor, to display said fused information within an element of a graphical user interface.

3. The program analysis system of claim 1 further comprising a plan generator comprising instructions stored in said memory and operable to cause said system, under control of said processor, to generate a plan for said target program based on said fused information.

4. The program analysis system of claim 3, wherein said plan for said target program comprises a program migration plan.

5. The program analysis system of claim 4, wherein the program migration plan comprises at least one of a service, estimated project cost and estimated project duration.

6. The program analysis system of claim 3, wherein generating said plan for said target program based on said fused information comprises analyzing said fused information to identify a service compatible with said target program.

7. The system of claim 3, wherein said plan is at least one of a program redesign plan, program update plan and program managing plan for said target program.

8. The system of claim 6, wherein analyzing said fused information to identify a service compatible with said target is based on one of performance requirements, network bandwidth requirements, program operating parameters, and user information for target program.

9. The system of claim 1, wherein analyzing said target computer system to identify first information characteristics for said target program comprises identifying information characteristics corresponding to at least one of process information, application information and system information of said target program.

10. The system of claim 1, wherein analyzing said target computer system to identify first information characteristics for said target program comprises storing said first information characteristics within said memory.

11. The system of claim 1, wherein review said one or more of information sources external from said target computer system to identify said second information characteristics comprises storing said second information characteristics within said memory.

12. The system of claim 1, wherein said one or more information sources external from said target computer system comprises one or more internet based sources.

13. The system of claim 1, wherein identifying second information characteristics comprises identifying said second information characteristics from at least one of :
devices on which the program is running, devices interacting with target program, devices which impact target program, devices running programs similar to target program, and other programs interacting with target program.

14. The system of claim 1, wherein said information fuser component is further configured to detect at least one issue corresponding to target program based on at least one of said first information characteristics and said second information characteristics.

15. The system of claim 1, wherein said second information characteristics comprises user information corresponding to a person and company.

16. The system of claim 1, wherein identifying said first information characteristics for target program comprises analyzing a first device of said target computer system and a second device of said target computer system, wherein target program is only running on said first device and wherein first information corresponds to said first device and said second device.
